(19) United States
(12) Patent Application Publication
(10) Pub. No.: US 2024/0214040 A1
(43) Pub. Date: Jun. 27, 2024

(54) METHOD FOR SIGNAL RELAYING IN THE MIMO BASED RELAY COMMUNICATION SYSTEM AND APPARATUS THEREOF

(71) Applicant: Gumi Electronics & Information Technology Research Institute, Gumi-si (KR)

(72) Inventors: Yong An JUNG, Gumi-si (KR); Sang Bong BYUN, Gumi-si (KR); Sung Hun LEE, Gumi-si (KR); Dong Cheul HAN, Gumi-si (KR); Soo Hyun CHO, Gumi-si (KR)

(21) Appl. No.: 18/350,594

(22) Filed: Jul. 11, 2023

(30) Foreign Application Priority Data
Dec. 14, 2022 (KR) 10-2022-0174372

(51) Int. Cl. H04B 7/0456

(52) U.S. Cl. CPC H04B 7/046

(57) ABSTRACT

An object of the present disclosure is to provide a method for high-speed signal relaying based on an MIMO based relay communication system and an apparatus thereof, which use a space time block code (STBC) based two-way relay technology in order to improve transmission rate reduction which occurs upon relaying a transmission signal by using a half duplex relay, and removes an inter relay interference which occurs between a plurality of relays used when using the two-way relay technology by using multiple input multiple output (MIMO) signal detection. In order to achieve the object, the method for high-speed signal relaying in the MIMO based relay communication system includes: receiving, by a plurality of relays, data signals transmitted from a sender by a reception unit during respective time slots; and removing, by a removal unit, an inter relay interference (IRI) component generated by using the plurality of relays.

### CROSS-REFERENCE TO RELATED APPLICATIONS

This application claims the priority of Korean Patent Application No. 10-2022-0174372 filed on Dec. 14, 2022, in the Korean Intellectual Property Office, the disclosure of which is incorporated herein by reference.

### BACKGROUND OF THE INVENTION

### Field of the Invention

The present disclosure relates to a method for high speed signal relaying in an MIMO based relay communication system and an apparatus thereof, and more particularly, to a method for high-speed signal relaying in an MIMO based relay communication system and an apparatus thereof, which remove an inter relay interference component between relays by using MIMO signal detection in a wireless communication system.

### Description of the Related Art

One of the most representative methods to increase the coverage of various wireless communication networks, including mobile communication, is a relay communication technology.

A relay used for such a relay communication technology can be divided into a full duplex scheme relay which can simultaneously performing transmission and reception of a signal and a half duplex scheme relay which cannot perform simultaneously transmission and reception.

In recent years, a half duplex relay communication environment is being used to enhance the realistic coverage limits that can be accommodated by a mobile communication network base station.

However, the half duplex relay has a problem in which the maximum transmission rate that can be achieved linearly decreases as the number of hops increases, and a solution for the problem is required.

Further, a method for removing inter relay interference (IRI) which can occur when solving a reduction problem of a transmission rate is required.

### SUMMARY OF THE INVENTION

In order to solve the problem in the related art, an object of the present disclosure is to provide a method for high-speed signal relaying based on an MIMO based relay communication system and an apparatus thereof, which use a space time block code (STBC) based two-way relay technology in order to improve transmission rate reduction which occurs upon relaying a transmission signal by using a half duplex relay, and removes an inter relay interference which occurs between a plurality of relays used when using the two-way relay technology by using multiple input multiple output (MIMO) signal detection.

In order to achieve the object, a method for high-speed signal relaying in the MIMO based relay communication system includes: receiving, by a plurality of relays, data signals transmitted from a sender by a reception unit during respective time slots; and removing, by a removal unit, an inter relay interference (IRI) component generated by using the plurality of relays.

Further, in the method for high-speed signal relaying in the MIMO based relay communication system, the sender transmits data signals X₁ and X₂ to one relay of the plurality of relays by using an STBC scheme during time slots T₁ and T₂.

Further, in the method for high-speed signal relaying in the MIMO based relay communication system, the sender transmits data signals X₃ and X₄ to the other one relay of the plurality of relays by using the STBC scheme during time slots T₃ and T₄.

Further, in the method for high-speed signal relaying in the MIMO based relay communication system, demodulation signals \hat{x}₁ and \hat{x}₂ are transmitted from one relay of the plurality of relays to a receiver by using the STBC scheme during the time slots T₃ and T₄.

Further, in the method for high-speed signal relaying in the MIMO based relay communication system, the demodulation signals \hat{x}₁ and \hat{x}₂ are transmitted to the other relay of the plurality of relays to cause the IRI.

Further, in the method for high-speed signal relaying in the MIMO based relay communication system, the data signal received by the other relay of the plurality of relays is Equation 1 below.

$$y = [ {\begin{matrix}{y}_{1 , {T}_{3}} & {y}_{2 , {T}_{3}} & {y}_{3 , {T}_{4}} & {y}_{4 , {T}_{4}} ]\end{matrix}}^{T} \qquad [ Equation 1 ]$$

Further, in the method for high-speed signal relaying in the MIMO based relay communication system, the IRI is separated by applying MIMO signal detection to Equation 1 above.

Further, the method for high-speed signal relaying in the MIMO based relay communication system includes: selecting, by a selection unit, a plurality of relays; and transmitting, by a transmission unit, data signals from the sender to the plurality of relays, respectively.

Further, in order to achieve the object, an apparatus for high-speed signal relaying in an MIMO based relay communication system performed by the method for high-speed signal relaying in the MIMO based relay communication system.

Meanwhile, in order to achieve the object, an apparatus for high-speed signal relaying in an MIMO based relay communication system includes: a selection unit selecting a plurality of relays; a transmission unit transmitting a data signal to the selected relay; a reception unit receiving data signals transmitted from a sender during respective time slots; and a removal unit removing an inter relay interference (IRI) component generated by using the plurality of relays.

Further, in the apparatus for high-speed signal relaying in the MIMO based relay communication system, the sender transmits data signals X₁ and X₂ to one relay of the plurality of relays by using an STBC scheme during time slots T₁ and T₂.

Further, in the apparatus for high-speed signal relaying in the MIMO based relay communication system, the sender transmits data signals X₃ and X₄ to the other one relay of the plurality of relays by using the STBC scheme during time slots T₃ and T₄.

Further, in the apparatus for high-speed signal relaying in the MIMO based relay communication system, demodulation signals \hat{x}₁ and \hat{x}₂ are transmitted from one relay of the plurality of relays to a receiver by using the STBC scheme during the time slots T₃ and T₄.

Further, in the apparatus for high-speed signal relaying in the MIMO based relay communication system, the demodulation signals \hat{x}₁ and \hat{x}₂ are transmitted to the other relay of the plurality of relays to cause the IRI.

Further, in the apparatus for high-speed signal relaying in the MIMO based relay communication system, the data signal received by the other relay of the plurality of relays is Equation 1 below.

$$y = [ {\begin{matrix}{y}_{1 , {T}_{3}} & {y}_{2 , {T}_{3}} & {y}_{3 , {T}_{4}} & {y}_{4 , {T}_{4}} ]\end{matrix}}^{T} \qquad [ Equation 1 ]$$

Further, in the apparatus for high-speed signal relaying in the MIMO based relay communication system, the IRI is separated by applying MIMO signal detection to Equation 1 above.

Specific details of other exemplary embodiments are included in “Details for carrying out the invention” and accompanying “drawings”.

Advantages and/or features of the present disclosure, and a method for achieving the advantages and/or features will become obvious with reference to various exemplary embodiments to be described below in detail together with the accompanying drawings.

However, the present disclosure is not limited only to a configuration of each exemplary embodiment disclosed below, but may also be implemented in various different forms. The respective exemplary embodiments disclosed in this specification are provided only to complete disclosure of the present disclosure and to fully provide those skilled in the art to which the present disclosure pertains with the category of the invention, and the present disclosure will be defined only by the scope of each claim of the claims.

According to the present disclosure, there is an effect in that a space time block code (STBC) based two-way relay technology is used in order to improve transmission rate reduction which occurs upon relaying a transmission signal by using a half duplex relay, and an inter relay interference which occurs between a plurality of relays used when using the two-way relay technology is removed by using multiple input multiple output (MIMO) signal detection.

### BRIEF DESCRIPTION OF THE DRAWINGS

FIG. 1 is a block diagram illustrating a configuration of an MIMO based relay communication system according to an exemplary embodiment of the present disclosure.

FIG. 2 is a block diagram illustrating a configuration of an apparatus for high-speed signal relaying in an MIMO based relay communication system according to an exemplary embodiment of the present disclosure.

FIG. 3 is a flowchart illustrating a configuration of a method for high-speed signal relaying in an MIMO based relay communication system according to an exemplary embodiment of the present disclosure.

FIG. 4 is a graph illustrating a comparison of throughput performances of the method for high-speed signal relaying in an MIMO based relay communication system according to an exemplary embodiment of the present disclosure and a method related art.

### DETAILED DESCRIPTION OF THE PREFERRED EMBODIMENT

Before describing the present disclosure in detail, the terms or words used in this specification should not be construed as being unconditionally limited to their ordinary or dictionary meanings, and in order for the inventor of the present disclosure to describe his/her invention in the best way, concepts of various terms may be appropriately defined and used, and furthermore, the terms or words should be construed as means and concepts which are consistent with a technical idea of the present disclosure.

That is, the terms used in this specification are only used to describe preferred embodiments of the present disclosure, and are not used for the purpose of specifically limiting the contents of the present disclosure, and it should be noted that the terms are defined by considering various possibilities of the present disclosure.

Further, in this specification, it should be understood that, unless the context clearly indicates otherwise, the expression in the singular may include a plurality of expressions, and similarly, even if it is expressed in plural, it should be understood that the meaning of the singular may be included.

In the case where it is stated throughout this specification that a component “includes” another component, it does not exclude any other component, but further includes any other component unless otherwise indicated.

Furthermore, it should be noted that when it is described that a component “exists in or is connected to” another component, this component may be directly connected or installed in contact with another component, and in inspect to a case where both components are installed spaced apart from each other by a predetermined distance, a third component or means for fixing or connecting the corresponding component to the other component may exist, and the description of the third component or means may be omitted.

On the contrary, when it is described that a component is “directly connected to” or “directly accesses” to another component, it should be understood that the third element or means does not exist.

Similarly, it should be construed that other expressions describing the relationship of the components, that is, expressions such as “between” and “directly between” or “adjacent to” and “directly adjacent to” also have the same purpose.

In addition, it should be noted that if terms such as “one side” “other side” “one side” “other side” “first” “second”, etc., are used in this specification, the terms are used to clearly distinguish one component from the other component and a meaning of the corresponding component is not limited used by the terms.

Further, in this specification, if terms related to locations such as “upper”, “lower”, “left”, “right”, etc., are used, it should be understood that the terms indicate a relative location in the drawing with respect to the corresponding component and unless an absolute location is specified for their locations, these location-related terms should not be construed as referring to the absolute location.

Further, in this specification, in specifying the reference numerals for each component of each drawing, the same component has the same reference number even if the component is indicated in different drawings, that is, the same reference number indicates the same component throughout the specification.

In the drawings attached to this specification, a size, a location, a coupling relationship, etc. of each component constituting the present disclosure may be described while being partially exaggerated, reduced, or omitted for sufficiently clearly delivering the spirit of the present disclosure, and thus the proportion or scale may not be exact.

Further, hereinafter, in describing the present disclosure, a detailed description of a configuration determined that may unnecessarily obscure the subject matter of the present disclosure, for example, a detailed description of a known technology including the prior art may be omitted.

Hereinafter, exemplary embodiments of the present disclosure will be described in detail with reference to related drawings.

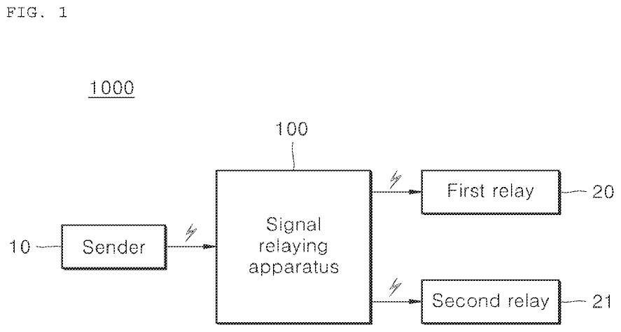

FIG. 1 is a block diagram illustrating a configuration of an MIMO based relay communication system according to an exemplary embodiment of the present disclosure.

Referring to FIG. 1, an MIMO based relay communication system 1000 includes a sender 10, a first relay 20 and a second relay 21 which are a plurality of relays, and a signal relaying device 100.

In the exemplary embodiment, for easy description, it is described that the plurality of relays are two relays, but the present disclosure is not limited thereto, and multiple relays may be used in order to enhance a data transmission rate.

A data signal transmitted by the sender 10 is received by a receiver (not illustrated) through a relay.

In an exemplary embodiment of the present disclosure, a half duplex scheme relay is used by considering a half duplex relay communication environment for enhancing the realistic coverage limits that may be accommodated by a mobile communication network base station.

Since a maximum transmission rate achievable linearly decreases as the number of hops increases, the half duplex relay should solve such a problem.

In the exemplary embodiment, a wasted transmission idle time is reduced by applying a two-way technology to solve a transmission rate reduction problem.

However, since two relays are used in such a process, inter relay interference (IRI) occurs, and an MIMO signal detection technique is used in order to remove the IRI.

The present disclosure provides a method for high-speed signal relaying and an apparatus thereof, which may enhance a data transmission rate in a half duplex relay communication for solving a transmission rate reduction problem which occurs upon relaying a transmission signal using a half duplex relay in a wireless communication system.

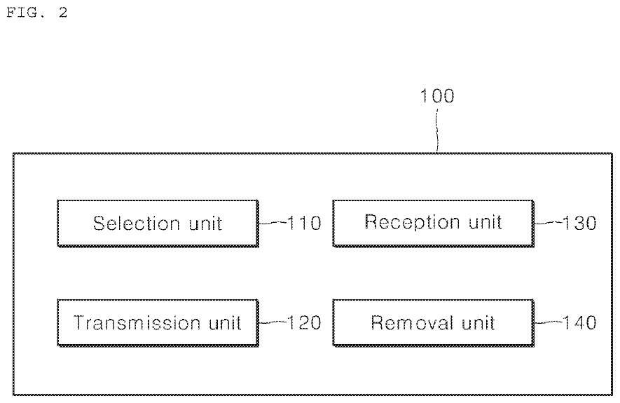

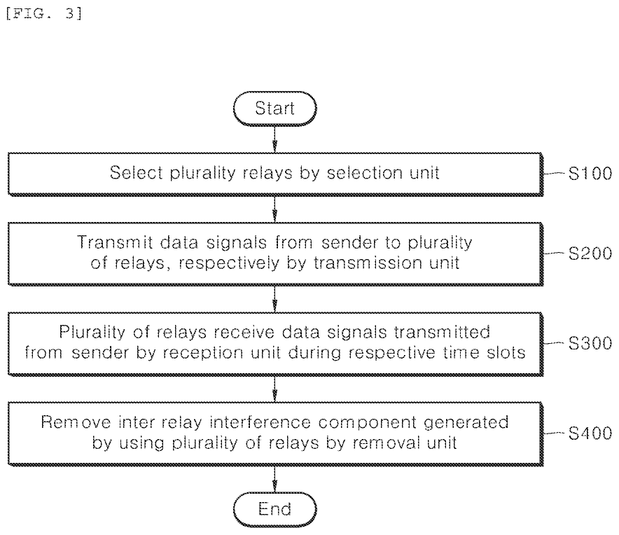

This will be described in more detail with reference to FIGS. 2 and 3.

FIG. 2 is a block diagram illustrating a configuration of an apparatus for high-speed signal relaying in an MIMO based relay communication system according to an exemplary embodiment of the present disclosure.

Referring to FIG. 2, in the MIMO based relay communication system 100, a high-speed signal relaying apparatus 100 includes a selection unit 110, a transmission unit 120, a reception unit 130, and a removal unit 140.

The selection unit 110 selects a plurality of relays 20 and 21.

In the exemplary embodiment, for easy description, it is described that the plurality of relays are two relays, but the present disclosure is not limited thereto, and multiple relays may be used in order to enhance a data transmission rate.

That is, the selection unit 110 selects a first relay 20 and a second relay 21.

The transmission unit 120 transmits a data signal with the selected relay.

The reception unit 130 receives the data signal transmitted from the sender 10 during each time slot.

The removal unit 140 removes an inter relay interference component generated by using the plurality of relays.

In the present disclosure, in order to enhance the data transmission rate of a half duplex relay apparatus, a wasted transmission idle time may be reduced by using a two-way relay.

Table 1 below is a signal transmission table used in a technique in the related art, and a table for this may be defined as follows.

TABLE 1

| | |
|---|---|
| S | R |

| | A₁ | A₂ | A₁ | A₂ |
|---|---|---|---|---|
| T₁ | x₁ | x₂ | | |
| T₂ | −x₂ [symbol] | x₁ [symbol] | | |
| T₃ | | | \hat{x}₁ | \hat{x}₂ |
| T₄ | | | −\hat{x}₂ [symbol] | \hat{x}₁ [symbol] |

[symbol]

indicates data missing or illegible when filed

In Table 1 above, S means the sender and R means the relay.

Further, A₁ and A₂ mean indexes 1 and 2 of a multiple input multiple output (MIMO) transmission antenna, respectively.

As a transmission step of a signal, data X₁ and X₂ are transmitted from the S to the R by using a space time block code (STBC) during time slots of T₁ and T₂, and demodulation signals \hat{x}₁ and \hat{x}₂ are transmitted from the R to the receiver by using the STBC during time slots T₃ and T₄.

Since the sender does not transmit different signals during the time slots T₃ and T₄ by considering the IRI component, a part where the time slot is wasted may be identified.

In the present disclosure, a signal relaying technique which may enhance the transmission rate while transmitting data by using two relays, and a signal transmission table for the signal relaying technique is defined as in Table 2 below.

Table 2 below is a signal transmission table used in the method according to an exemplary embodiment of the present disclosure.

TABLE 2

| | | |
|---|---|---|
| S | R₁ | R₂ |

| | A₁ | A₂ | A₁ | A₂ | A₁ | A₂ |
|---|---|---|---|---|---|---|
| T₁ | x₁ | x₂ | | | | |
| T₂ | −x₂* | x₁* | | | | |
| T₃ | x₃ | x₄ | \hat{x}₁ | \hat{x}₂ | | |
| T₄ | −x₂* | x₁* | −\hat{x}₂* | \hat{x}₁* | | |

Table 2 above means a signal transmission table when the total number of time slots is designated as 4, S means the sender 10, and R₁ and R₂ mean the first relay 20 and the second relay 21, respectively.

As the signal transmission step, the sender (10) S transmits data signals X₁ and X₂ to the first relay (20) R₁ by using the STBC scheme during the time slots T₁ and T₂.

However, unlike the technique in the related art, in the technique in the exemplary embodiment, the sender (10) S transmits the data X₃ and X₄ to the second relay (21) R₂ by using the STBC during the time slots T₃ and T₄.

The demodulation signals \hat{x}₁ and \hat{x}₂ are transmitted from the first relay (20) R₁ to a receiver (not illustrated) by using the STBC during the same time, i.e., the same time slot, and since the demodulation signals are also propagated to the second relay (21) R₂, the inter relay inference occurs.

In the technique in the related art, since the signal may not be simultaneously transmitted and received as in Table 1 above, the wasted time slot is generated in the sender S, but in the technique according to the exemplary embodiment, the signal is transmitted without the waste of the time slot in the sender (10) S as in Table 2 above.

The maximum transmission rates of the technique in the related art and the technique according to the exemplary embodiment are 2n/4n and (4n−2)/4n, respectively, and as the time slot increases, the technique according to the exemplary embodiment has the same transmission rate as a system that does not perform relaying.

In other words, in the high-speed signal relaying apparatus 100 of the MIMO based relay communication system 1000 according to the present disclosure, the sender 10 transmits the data signals X₁ and X₂ to the first relay 20 which is one relay of the plurality of relays by using the STBC scheme during the time slots T₁ and T₂.

Further, the sender 10 transmits the data signals X₁ and X₂ to the second relay 21 which is the other one relay of the plurality of relays by using the STBC scheme during the time slots T₃ and T₄.

Further, the demodulation signals \hat{x}₁ and \hat{x}₂ are transmitted from the first relay 20 which is one relay of the plurality of relays to the receiver (not illustrated) by using the STBC scheme during the time slots T₃ and T₄ as the same time.

In this case, the demodulation signals \hat{x}₁ and \hat{x}₂ are transmitted to the other relay of the plurality of relays to cause the IRI.

Here, the data signal received by the second relay 21 which is the other one relay of the plurality of relays may be expressed as in Equation 1 below.

$$y = [ {\begin{matrix}{y}_{1 , {T}_{3}} & {y}_{2 , {T}_{3}} & {y}_{3 , {T}_{4}} & {y}_{4 , {T}_{4}} ]\end{matrix}}^{T} \qquad [ Equation 1 ]$$

Further, Equation 2 below is an equation expressing Equation 1 above.

$$[ \begin{matrix}{y}_{1 , {T}_{3}} \\ {y}_{2 , {T}_{3}} \\ {y}_{3 , {T}_{4}}^{*} \\ {y}_{4 , {T}_{4}}^{*}\end{matrix} ] = [ \begin{matrix}{h}_{11 , {R}_{1} , {R}_{2}} & {h}_{12 , {R}_{1} , {R}_{2}} & {h}_{11 , {SR}_{2}} & {h}_{12 , {SR}_{2}} \\ {h}_{21 , {R}_{1} , {R}_{2}} & {h}_{22 , {R}_{1} , {R}_{2}} & {h}_{21 , {SR}_{2}} & {h}_{22 , {SR}_{2}} \\ {h}_{12 , {R}_{1} , {R}_{2}}^{*} & - {h}_{11 , {R}_{1} , {R}_{2}}^{*} & {h}_{12 , {SR}_{2}}^{*} & - {h}_{11 , {SR}_{2}}^{*} \\ {h}_{22 , {R}_{1} , {R}_{2}}^{*} & - {h}_{12 , {R}_{1} , {R}_{2}}^{*} & {h}_{22 , {SR}_{2}}^{*} & - {h}_{21 , {SR}_{2}}^{*}\end{matrix} ] [ \begin{matrix}{\hat{x}}_{1} \\ {\hat{x}}_{2} \\ {x}_{3} \\ {x}_{4}\end{matrix} ] \qquad [ Equation 2 ]$$

In Equation 1 above, it is assumed that there is no noise for convenience, and h_{ij,R}_{₁}_{R}_{₂} represents a radio channel coefficient from a jth transmission antenna of R₁ to an ith reception antenna of R₂, and this means a radio channel corresponding to the IRI component.

In the present disclosure, X₃ and X₄ are detected by applying an MIMO signal detection technology to Equation 1 to separate the IRI component.

Here, as the MIMO signal detection technology, a technique such as QRD-M or ZF may be used.

For example, a QRD-M technique determines a signal detection ranking based on channel sorting, and in general, since the IRI component is more dominant than a desired component, a post SINR may be maximized by removing the IRI through the channel sorting.

Meanwhile, in the MIMO based relay communication system according to the present disclosure, the high-speed signal relaying apparatus may be performed by the high-speed signal relaying method in the MIMO based relay communication system.

FIG. 3 is a flowchart illustrating a configuration of a method for high-speed signal relaying in an MIMO based relay communication system according to an exemplary embodiment of the present disclosure.

Referring to FIG. 3, the high-speed signal relaying method in the MIMO based relay communication system according to an exemplary embodiment of the present disclosure includes four core steps.

In a first step S100, a selection unit 110 selects a plurality of relays (e.g., a first relay 20 and a second relay 21).

The selection unit 110 selects a plurality of relays.

In the exemplary embodiment, for easy description, it is described that the plurality of relays are two relays, but the present disclosure is not limited thereto, and multiple relays may be used in order to enhance a data transmission rate.

That is, the selection unit 110 selects the first relay and the second relay 21.

In a second step S200, data signals are transmitted from a sender 10 to a plurality of relays 20 and 21, respectively by a transmission unit 120.

The transmission unit 120 transmits the data signal with the selected relay.

More specifically, the sender 10 transmits respective data to the first relay 20 and the second relay 21 through four time slots.

In a third step S300, the plurality of relays 20 and 21 receives data signals transmitted from the sender 10 by a reception unit 130 during respective time slots.

The reception unit 130 receives the data signals transmitted from the sender 10 during the respective time slots.

More specifically, the first relay 20 receives transmission signals of time slots 1 and 2.

Further, the second relay 21 receives transmission signals of time slots 3 and 4, and a transmission signal of the first relay 20, i.e., an interference signal.

In a fourth step S400, a removal unit 140 removes an inter relay interference (IRI) component generated by using the plurality of relays 20 and 21.

The removal unit 140 removes the inter relay interference component generated by using the plurality of relays.

That is, the removal unit removes the interference component from the signal received by the second relay 21.

Thereafter, the second relay 21 transmits the signal from which the interference component is removed to a receiver (not illustrated).

In the present disclosure, in order to enhance the data transmission rate of a half duplex relay apparatus, a wasted transmission idle time may be reduced by using a two-way relay.

In Table 1 described above, S means the sender and R means the relay.

Further, A₁ and A₂ mean indexes 1 and 2 of a multiple input multiple output (MIMO) transmission antenna, respectively.

As a transmission step of a signal, data X₁ and X₂ are transmitted from the S to the R by using a space time block code (STBC) during time slots of T₁ and T₂, and demodulation signals \hat{x}₁ and \hat{x}₂ are transmitted from the R to the receiver by using the STBC during time slots T₃ and T₄.

Since the sender does not transmit different signals during the time slots T₃ and T₄ by considering the IRI component, a part where the time slot is wasted may be identified.

In the present disclosure, a signal relaying technique which may enhance the transmission rate while transmitting data by using two relays, and a signal transmission table for the signal relaying technique is defined as in Table 2 described above.

Table 2 described above means a signal transmission table when the total number of time slots is designated as 4, S means the sender 10, and R₁ and R₂ mean the first relay and the second relay 21, respectively.

As the signal transmission step, the sender (10) S transmits data signals X₁ and X₂ to the first relay (20) R₁ by using the STBC scheme.

However, unlike the technique in the related art, in the technique in the exemplary embodiment, the sender (10) S transmits the data X₃ and X₄ to the second relay (21) R₂ by using the STBC during the time slots T₃ and T₄.

The demodulation signals \hat{x}₁ and \hat{x}₂ are transmitted from the first relay (20) R₁ to a receiver (not illustrated) by using the STBC during the same time, i.e., the same time slot, and since the demodulation signals are also propagated to the second relay (21) R₂, the inter relay inference occurs.

In the technique in the related art, since the signal may not be simultaneously transmitted and received as in Table 1 above, the wasted time slot is generated in the sender S, but in the technique according to the exemplary embodiment, the signal is transmitted without the waste of the time slot in the sender (10) S as in Table 2 above.

The maximum transmission rates of the technique in the related art and the technique according to the exemplary embodiment are 2n/4n and (4n−2)/4n, respectively, and as the time slot increases, there is an effect in that the technique according to the exemplary embodiment has the same transmission rate as a system that does not perform relaying.

In other words, in the high-speed signal relaying method of the MIMO based relay communication system according to the present disclosure, the sender transmits the data signals X₁ and X₂ to one relay of the plurality of relays by using the STBC scheme during the time slots T₁ and T₂.

Further, the sender transmits the data signals X₁ and X₂ to the other one relay of the plurality of relays by using the STBC scheme during the time slots T₃ and T₄.

Further, the demodulation signals \hat{x}₁ and \hat{x}₂ are transmitted from the first relay 20 which is one relay of the plurality of relays to the receiver (not illustrated) by using the STBC scheme during the time slots T₃ and T₄ as the same time.

In this case, the demodulation signals \hat{x}₁ and \hat{x}₂ are transmitted to the other relay of the plurality of relays to cause the IRI.

Here, the data signal received by the second relay 21 which is the other one relay of the plurality of relays may be expressed as in Equation 1 described above.

Further, Equation 2 described above is an equation expressing Equation 1 above.

In Equation 1 described above, it is assumed that there is no noise for convenience, and h_{ij,R}_{₁}_{R}_{₂} represents a radio channel coefficient from a jth transmission antenna of R₁ to an ith reception antenna of R₂, and this means a radio channel corresponding to the IRI component.

In the present disclosure, X₃ and X₄ are detected by applying an MIMO signal detection technology to Equation 1 to separate the IRI component.

Here, as the MIMO signal detection technology, a technique such as QRD-M or ZF may be used.

For example, a QRD-M technique determines a signal detection ranking based on channel sorting, and in general, since the IRI component is more dominant than a desired component, a post SINR may be maximized by removing the IRI through the channel sorting.

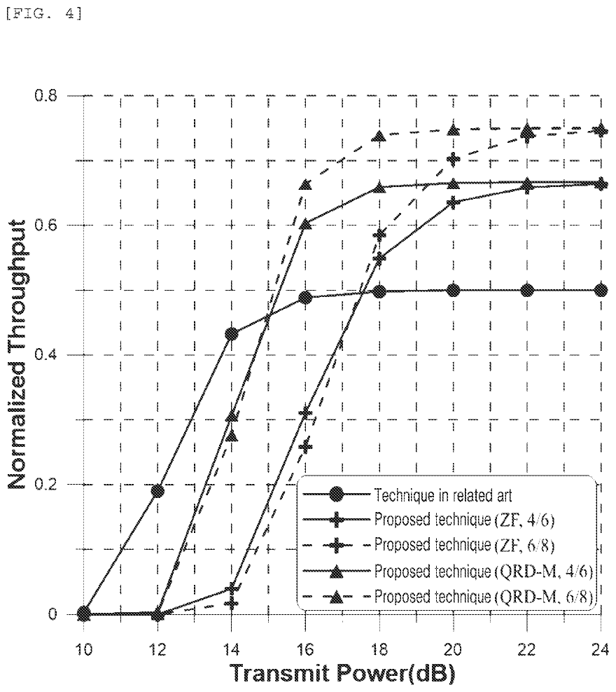

FIG. 4 is a graph illustrating a comparison of throughput performances of the method for high-speed signal relaying in an MIMO based relay communication system according to an exemplary embodiment of the present disclosure and a method related art.

Referring to FIG. 4, the maximum transmission rates of the technique in the related art and the technique according to the present disclosure are 2n/4n and (4n−2)/4n, respectively, and as the time slot increases, there is an advantage in that the technique according to the present disclosure has the same transmission rate as a system that does not perform relaying.

As described above, according to the present disclosure, there is an effect in that a space time block code (STBC) based two-way relay technology is used in order to improve transmission rate reduction which occurs upon relaying a transmission signal by using a half duplex relay, and an inter relay interference which occurs between a plurality of relays used when using the two-way relay technology is removed by using multiple input multiple output (MIMO) signal detection.

In the above, although several preferred embodiments of the present disclosure have been described with some examples, the descriptions of various exemplary embodiments described in the “Specific Content for Carrying Out the Invention” item are merely exemplary, and it will be appreciated by those skilled in the art that the present disclosure can be variously modified and carried out or equivalent executions to the present disclosure can be performed from the above description.

In addition, since the present disclosure can be implemented in various other forms, the present disclosure is not limited by the above description, and the above description is for the purpose of completing the disclosure of the present disclosure, and the above description is just provided to completely inform those skilled in the art of the scope of the present disclosure, and it should be known that the present disclosure is only defined by each of the claims.

1. A method for high-speed signal relaying in an MIMO based relay communication system, the method comprising:
receiving, by a plurality of relays, data signals transmitted from a sender by a reception unit during respective time slots; and
removing, by a removal unit, an inter relay interference (IRI) component generated by using the plurality of relays.

2. The method of claim 1, wherein the sender transmits data signals X₁ and X₂ to one relay of the plurality of relays by using an STBC scheme during time slots T₁ and T₂.

3. The method of claim 2, wherein the sender transmits data signals X₃ and X₄ to the other one relay of the plurality of relays by using the STBC scheme during time slots T₃ and T₄.

4. The method of claim 3, wherein demodulation signals \hat{x}₁ and \hat{x}₂ are transmitted from one relay of the plurality of relays to a receiver by using the STBC scheme during the time slots T₃ and T₄.

5. The method of claim 4, wherein the demodulation signals \hat{x}₁ and \hat{x}₂ are transmitted to the other relay of the plurality of relays to cause the IRI.

6. The method of claim 5, wherein the data signal received by the other relay of the plurality of relays is according to equation:
$$y = {[ \begin{matrix}{y}_{1 , {T}_{3}} & {y}_{2 , {T}_{3}} & {y}_{3 , {T}_{4}} & {y}_{4 , {T}_{4}}\end{matrix} ]}^{T}$$

7. The method of claim 6, wherein the IRI is separated by applying MIMO signal detection to the equation.

8. The method of claim 1, comprising:
selecting, by a selection unit, a plurality of relays; and
transmitting, by a transmission unit, data signals from the sender to the plurality of relays, respectively.

9. An apparatus for high-speed signal relaying in an MIMO based relay communication system performed by the method for high-speed signal relaying in the MIMO based relay communication system of claim 1.

10. An apparatus for high-speed signal relaying in an MIMO based relay communication system, the apparatus comprising:
a selection unit selecting a plurality of relays;
a transmission unit transmitting a data signal to the selected relay;
a reception unit receiving data signals transmitted from a sender during respective time slots; and
a removal unit removing an inter relay interference (IRI) component generated by using the plurality of relays.

11. The apparatus of claim 10, wherein the sender transmits data signals X₁ and X₂ to one relay of the plurality of relays by using an STBC scheme during time slots T₁ and T₂.

12. The apparatus of claim 11, wherein the sender transmits data signals X₃ and X₄ to the other one relay of the plurality of relays by using the STBC scheme during time slots T₃ and T₄.

13. The apparatus of claim 12, wherein demodulation signals \hat{x}₁ and \hat{x}₂ are transmitted from one relay of the plurality of relays to a receiver by using the STBC scheme during the time slots T₃ and T₄.

14. The apparatus of claim 13, wherein the demodulation signals \hat{x}₁ and \hat{x}₂ are transmitted to the other relay of the plurality of relays to cause the IRI.

15. The apparatus of claim 14, wherein the data signal received by the other relay of the plurality of relays is according to equation:
$$y = {[ \begin{matrix}{y}_{1 , {T}_{3}} & {y}_{2 , {T}_{3}} & {y}_{3 , {T}_{4}} & {y}_{4 , {T}_{4}}\end{matrix} ]}^{T}$$

16. The apparatus of claim 15, wherein the IRI is separated by applying MIMO signal detection to the question.
